(19) United States
(12) Patent Application Publication
(10) Pub. No.: US 2011/0189071 A1
(43) Pub. Date: Aug. 4, 2011

(54) MESOPOROUS NANOSTRUCTURES

(76) Inventors: Jackie Y. Ying, Nanos (SG); Yu Han, Nanos (SG); Leng Leng Chng, Nanos (SG); Lan Zhao, Nanos (SG)

(21) Appl. No.: 12/811,783

(22) PCT Filed: Jan. 5, 2009
(86) PCT No.: PCT/SG09/00003

§ 371 Date: Feb. 24, 2011

Related U.S. Application Data
(60) Provisional application No. 61/006,261, filed on Jan. 3, 2008.

(51) Int. Cl. C01B 33/12; B82Y 30/00

(52) U.S. Cl. 423/335; 977/762

(57) ABSTRACT

The invention provides a process for making a particulate mesoporous material. A solution comprising a surfactant and a base is combined with a hydrolysable precursor without agitating said solution. The resulting mixture is then allowed to stand without externally applied agitation for sufficient time for hydrolysis of the precursor to form the particulate mesoporous material.

### TECHNICAL FIELD

The present invention relates to mesoporous nanostructures and to a process for making them.

### BACKGROUND OF THE INVENTION

Novel ordered porous materials with unique pore structures and pore sizes in the mesoporous range (2-50 nm) are interesting for applications in catalysis, separation and drug delivery. Extensive research over the years has resulted in mesoporous materials with one-dimensional (1D), cage-like and bi-continuous pore structures.

Since the first discovery of ordered mesoporous silica, various mesoporous materials with distinct pore structures have been discovered. The mesostructures are often based on the structures of different liquid crystal phases, and are attained by the cooperative self-assembly of organic surfactants and inorganic silicate species. Discovery of new mesoporous silica structures often depends on the development of new surfactants with distinct properties. Bi-continuous phases belong to one of the most important families of the liquid crystals since their interfaces follow 3D periodic minimal surfaces to minimize the surface energy. For example, the three bi-continuous cubic phases found in lyotropiC liquid crystals correspond to gyroidal (G, Ia-3d), diamondoid (D, Pn-3m) and primitive (P, Im-3m) minimal surfaces. The corresponding mesoporous silica has been synthesized successfully as MCM-48 [Carlsson, A. et al. The structure of IMM-48 determined by electron crystallography. J. Electron Microsc. 48, 795-798 (1999)], AMS-10 [Gao, C., Sakamoto, Y., Sakamoto, K., Terasaki, O. & Che, S. Synthesis and characterization of mesoporous silica AMS-10 with bicontinuous cubic Pn-3m symmetery. Angew. Chem. Int. Ed. 45, 4295-4298 (2006)], and an unnamed material [Finnefrock, A. C. et al. Metal oxide containing mesoporous silica with bicontinuous Plumber's nightmare morphology from a block copolymer-hybrid mesophase. Angew. Chem. Int. Ed. 40, 1208-1211 (2001)], respectively. These materials are characterized by two interwoven but disconnected mesoporous channels, which are separated by a single continuous silica wall following the 3D periodic minimal surfaces. However, the synthesis of more complex tri- or multi-continuous mesostructures would require more rigorous conditions with rational design.

Periodically ordered mesoporous silica materials are characterized by large surface area, high porosity and uniform nanometer-sized pores. The ability to precisely control their structural features, such as pore size and shape, pore connectivity and arrangement, would be critical in optimizing their performance in catalysis, sensing, separation, electrochemical and optical applications. The structure of mesoporous silica depends heavily on the properties of the surfactant template, which directs the formation of various mesophases. Surfactant packing parameter, g=V/a₀l, where V is the volume of the hydrophobic chain, a₀ is the effective area of the polar head group, and l is the chain length, was introduced to explain the effect of surfactant molecular geometry on the mesostructure and pore size [(a) Q. S. Huo, D. I. Margolese, G. D. Sticky, Chem. Mater. 1996, 8, 1147. (b) T. Sun, J. Y. Ying, Nature 1997, 389, 704. (c) T. Sun, J. Y. Ying, Angew. Chem. Int. Ed. 1998, 37, 664]. In general, a smaller g value favors the formation of a mesophase with higher surface curvature. Besides the geometry of surfactant molecules, many other conditions such as co-solvents, pH, additives and counteranions may affect the final mesostructure via changing the g value. For example, Che et al. synthesized four types of mesophases, three-dimensional (3D) hexagonal P6₃/mmc, cubic Pm 3̅n, two-dimensional (2D) hexagonal p6 mm, and cubic Ia 3̅d, with the same surfactant cetyltriethylammonium bromide, by simply using different acids as the reaction media [S. Che, S. Lim, M. Kaneda, H. Yoshitake, O. Terasaki, T. Tatsumi, J. Am. Chem. Soc. 2002, 124, 13962]. Similar mesophase transformation was later realized in anionic surfactant system by adjusting the neutralization degree of the surfactant [C. Gao, Y. Sakamoto, K. Sakamoto, O. Terasaki, S. Che, Angew. Chem. Int. Ed. 2006, 45, 4295].

The morphological control of mesoporous silica is also of interest because of its importance for certain applications. Mesoporous silica nanoparticles have been used for controlled drug release system. Micron-sized spherical mesoporous silica particles have been used as a stationary phase in chromatography and as a catalytic support in packed bed reactor, showing high column efficiency and low back-pressure. Single crystals are fundamentally important for studying the structure and growth mechanism of mesoporous silica. Mesoporous silica fibres with hexagonally packed channels show great potential as waveguide and laser materials. Mesoporous silica fibres with 3-D cubic structures have not been reported.

Recently, the present inventors synthesized mesoporous silica materials with helical channels in highly concentrated ammonia solution using the achiral surfactant cetyltrimethylammonium bromide as template, and illustrated that their pitch length and particle morphology could be adjusted by varying the ammonia solution concentration [Y. Han, L. Zhao, J. Y. Ying, Adv. Mater. 2007, 19, 2454]. Several different approaches have been reported for preparing mesoporous silica fibres, including fibre-drawing from viscous gel, fibre preparation within a confined space, or spontaneous growth of fibres in solution. However, all of the fibres obtained from these methods contain 1D channel-like pores.

There is however still a need for a process capable of producing a mesoporous structure in fibres, in particular nanofibres.

### OBJECT OF THE INVENTION

It is the object of the present invention to at least partially satisfy the above need.

### SUMMARY OF THE INVENTION

In a broad form, the present invention provides a process for making a particulate mesoporous material comprising:
combining a solution comprising a surfactant and a base with a hydrolysable precursor; and
allowing the resulting mixture to stand without externally applied agitation for sufficient time to hydrolyze the precursor and form the particulate mesoporous material.

The solution and the precursor may be combined without agitation or with minimal agitation. The step of combining may comprise adding the hydrolysable precursor in a dropwise fashion to the solution whilst said solution is standing without agitation. It may comprise adding the hydrolysable precursor in a slow dropwise fashion to said solution whilst said solution is standing without agitation so as to avoid substantially disturbing the solution during the adding.

In a first aspect of the invention there is provided a process for making a particulate mesoporous material comprising:
combining a solution comprising a surfactant and a base with a hydrolysable precursor without agitating said solution; and
allowing the resulting mixture to stand without externally applied agitation for sufficient time for hydrolysis of the precursor to form the particulate mesoporous material.

The lack of agitation in either or both steps may reflect static conditions. Thus there is provided a process for making a particulate mesoporous material comprising:
combining a solution comprising a surfactant and a base with a hydrolysable precursor under static conditions; and
allowing the resulting mixture to stand under static conditions for sufficient time for hydrolysis of the precursor to form the particulate mesoporous material.

The following options may be used in conjunction with the first aspect (or the broad form of the invention described above), either individually or in any suitable combination.

The solution may be an aqueous solution.

The step of combining may comprise, or may consist of, adding the hydrolysable precursor to the solution.

The surfactant may be such that the concentration of the base in the solution controls the shape of particles of the particulate mesoporous material and/or the mesoporous structure of the particulate mesoporous material. Details of the surfactant are provided elsewhere in this specification. The mesoporous structure of the particulate mesoporous material made by the process may depend on the concentration of the base in the solution. It may be controllable by means of controlling the concentration of the base in the solution. The mesoporous structure of the particulate mesoporous material may have any one of a 3D hexagonal P6₃/mmc, P6₃/mcm, cubic Ia 3̅d, 2D hexagonal p6 mm or cubic Pm 3̅n mesophase, depending on the concentration of the base in the solution.

The base may be a water soluble amine. It may be ammonia.

The hydrolysable precursor may comprise a tetraalkoxysilane. It may comprise an alkyltrialkoxysilane. It may comprise a tetraalkoxysilane and an alkyltrialkoxysilane. It may additionally comprise a tetraalkyltitanate, a tetraalkylzirconate, an alkoxyaluminium compound or an alkoxyiron compound or it may comprise (in addition to the tetraalkoxysilane and/or alkyltrialkoxysilane) a mixture of any two or more of these. It may comprise a tetraalkoxysilane and/or an alkyltrialkoxysilane, whereby the mesoporous material comprises mesoporous silica and/or mesoporous alkylsilsesquioxane. It may be a tetraalkoxysilane, such as tetraethoxysilane, whereby the mesoporous material comprises mesoporous silica.

The mesoporous material may be in the form of nanofibres. The concentration of the base in the solution may be such that the mesoporous material is in the form of nanofibres having a 3D hexagonal P6₃/mmc or a cubic Pm 3̅n mesophase.

The concentration of base in the solution may be such that the mesoporous material is in the form of nanofibres having 6/mmm point group symmetry. It may be such that the mesoporous material has a tricontinuous structure. In the event that the base is ammonia, said ammonia may be in a concentration of about 0.5 to about 15 wt % in the solution. It may be in a concentration of about 0.5 to about 5%, or about 0.5 to about 2.5%, whereby the mesoporous material may be in the form of nanofibres.

The surfactant may comprise a trialkylammonium head group and a tail group which comprises an aryl group. The tail group may comprise a long chain alkyl group which is not attached directly to the aryl group. The surfactant may be chiral. Other options in regard to the surfactant are described elsewhere in this specification. The surfactant may a (1-alkylcarbornyl-2-phenyl-ethyl)-trialkylammonium halide. It may be (S)-(1-tetradecylcarbornyl-2-phenyl-ethyl)-dimethyl-ethyl-ammonium bromide. The surfactant should comprise two structural factors that influence the surfactant packing parameter g oppositely. This allows fine tuning of the surfactant packing by modifying the synthesis conditions.

The reaction may additionally comprise the step of calcining the resulting mesoporous material at a temperature and for a time sufficient to remove substantially all of the surfactant. The temperature may be about 500 to about 600° C., for example about 550° C.

In an example, the surfactant is a (S)-(1-tetradecylcarbornyl-2-phenyl-ethyl)-dimethyl-ethyl-ammonium halide, the base is ammonia at a concentration in the solution of about 0.5 to about 15%, the hydrolysable precursor is tetrethoxysilane and the process comprises calcining an initially formed mesoporous material at about 500 to about 600° C., whereby the particulate mesoporous material is mesoporous silica having a tricontinuous structure. The ammonia concentration may be about 0.5 to about 2.5%, whereby the mesoporous silica may be in the form of nanofibres.

The invention also provides a particulate mesoporous material made by the process of the first aspect. The material may be in the form of nanofibres. It may be in the form of substantially, or approximately, spherical microparticles. It may be in the form of amorphous or irregular shaped particles. It may be a mixture of these. The particles of the material may have a tricontinuous structure. They may be mesoporous nanofibres having a tricontinuous structure.

In an embodiment there is provided a process for making a particulate mesoporous material comprising:
combining an aqueous solution comprising a (1-alkylcarbornyl-2-phenyl-ethyl)-trialkylammonium halide surfactant and an amine with a hydrolysable precursor without agitating said solution; and
allowing the resulting mixture to stand without externally applied agitation for sufficient time for hydrolysis of the precursor to form the particulate mesoporous material.

In another embodiment there is provided a process for making a particulate mesoporous material comprising:
combining an aqueous solution comprising a (1-alkylcarbornyl-2-phenyl-ethyl)-trialkylammonium halide Surfactant and ammonia with a tetraalkoxysilane precursor without agitating said solution; and
allowing the resulting mixture to stand without externally applied agitation for sufficient time for hydrolysis of the precursor to form the particulate mesoporous material.

In another embodiment there is provided a process for making a particulate mesoporous material comprising:
combining an aqueous solution comprising a (1-alkylcarbornyl-2-phenyl-ethyl)-trialkylammonium halide surfactant and ammonia with a tetraalkoxysilane precursor without agitating said solution;
allowing the resulting mixture to stand without externally applied agitation for sufficient time for hydrolysis of the precursor to form the particulate mesoporous material; and
calcining the mesoporous material at 500-1000° C.

In another embodiment there is provided a process for making a particulate mesoporous material in the form of nanofibres, said process comprising:
combining an aqueous solution comprising a (1-alkylcarbornyl-2-phenyl-ethyl)-trialkylammonium halide surfactant and 0.5-5% w/v ammonia with a tetraalkoxysilane precursor without agitating said solution;
allowing the resulting mixture to stand without externally applied agitation for sufficient time for hydrolysis of the precursor to form the particulate mesoporous material; and
calcining the mesoporous material at 500-1000° C.

In a second aspect of the invention there is provided a particulate mesoporous material in the faun of nanofibres.

The following options may be used in conjunction with the second aspect, either individually or in any suitable combination.

The mesoporous material may have a 3D hexagonal P6₃/mmc, P6₃/mcm or a cubic Pm 3̅n mesophase. It may have 6/mmm point group symmetry. It may have a tricontinuous structure.

The nanofibres may have a mean diameter of about 50 to about 500 nm. They may have a mean length of about 5 to about 100 microns. They may have a mean BJH pore size of about 1 to about 10 nm.

In an embodiment there is provided a particulate mesoporous material in the form of tricontinuous nanofibres, said fibres having a mean diameter of about 50-500 nm, a mean length of about 5-100 microns and a 3D hexagonal P6₃/mmc structure.

In another embodiment there is provided a particulate mesoporous material in the form of tricontinuous nanofibres, said fibres having a mean diameter of about 50-500 nm, a mean length of about 5-100 microns and a cubic Pm 3̅n structure.

In a third aspect of the invention there is provided a surfactant for use in making a particulate mesoporous material, said surfactant comprising a trialkylammonium head group and a tail group comprising an aryl group and a long chain alkyl group, wherein the alkyl group is not attached directly to the aryl group. The surfactant may comprise two structural factors that influence the surfactant packing parameter g oppositely.

The tail group may be a 1-(1-alkylcarbornyl-2-arylethyl) group wherein the alkyl group is 8 to 18 carbon atoms in length.

The surfactant may be a 1-(1-tetradecylcarbornyl-2-phenyl-ethyl)-dimethyl-ethyl-ammonium halide.

In a particular embodiment the surfactant is (S)-(1-tetradecylcarbornyl-2-phenyl-ethyl)-dimethyl-ethyl-ammonium bromide.

In a fourth aspect of the invention there is provided a process for making the surfactant of the third aspect, said process comprising quaternising a tertiary amine with a short chain alkyl halide, wherein said tertiary amine comprises two short chain alkyl groups and a tail group, each attached to a nitrogen atom, said tail group comprising an aryl group and a long chain alkyl group wherein the alkyl group is not attached directly to the aryl group.

The tail group may be a 1-(1-alkylcarbornyl-2-arylethyl) group wherein the alkyl group is 8 to 18 carbon atoms in length. In this case the process may comprise reacting an N,N-dialkyl-arylalanine (wherein the alkyl groups are short chain alkyl groups) with a long chain alkyl primary amine so as to form the tertiary amine.

In an embodiment there is provided a process for making the surfactant of the third aspect, said process comprising:
reacting an N,N-dialkyl-phenylalanine (wherein the alkyl groups are short chain alkyl groups) with a long chain alkyl primary amine so as to form a tertiary amine containing a 1-(1-alkylcarbornyl-2-phenylethyl) group wherein the alkyl group is 8 to 18 carbon atoms in length; and
quaternising the tertiary amine with a short chain alkyl halide.

In a fifth aspect of the invention there is provided use of a mesoporous material according to the second aspect, or the sixth aspect (described below), or of a mesoporous material made by the process of the first aspect, as a waveguide or as a laser material or in a catalytic, sensing, separation, controlled release (e.g. drug delivery), electrochemical or optical application.

In a sixth aspect of the invention there is provided a particulate mesoporous material having tricontinous structure.

The following options may be used in conjunction with the sixth aspect, either individually or in any suitable combination.

The mesoporous material may have 6/mmm point group symmetry.

The mesoporous material may have a mean BJH pore size of about 1 to about 10 nm.

The particulate mesoporous material may be made by the process of the first aspect.

The particulate mesoporous material may be in the form of nanofibres. The nanofibres may have a mean diameter of about 50 to about 500 nm. They may have a mean length of about 5 to about 100 microns.

In an embodiment there is provided a particulate mesoporous material having tricontinous structure, said material being in the form of nanofibres of mean diameter about 50 to about 500 nm and mean length of about 5 to about 100 microns.

### DETAILED DESCRIPTION OF THE INVENTION

The present invention relates to a process for making a particulate mesoporous material. In the process, a solution comprising a surfactant and a base is combined with a hydrolysable precursor without agitating said solution. The resulting mixture is then allowed to stand without externally applied agitation for sufficient time for hydrolysis of the precursor to form the particulate mesoporous material. The mesoporous material may comprise pores of relatively large diameter connected by windows of relatively small diameter. This structure provides for a large surface area and pore volume while maintaining relatively small apertures (the windows) for entry of materials into the pore structure. In this structure, the pores may be about 2 to about 10 nm in diameter, or about 2 to 5, 5 to 10 or 3 to 5 nm, e.g. about 2, 3, 4, 5, 6, 7, 8, 9 or 10 nm in diameter. The windows may be about 0.2 to about 2 nm in diameter, or about 0.2 to 1.5, 0.2 to 1, 0.2 to 0.5, 0.5 to 2, 1 to 2, 0.5 to 1.5, 0.5 to 1 or 1 to 1.5 nm, e.g. about 0.2, 0.3, 0.4, 0.5, 0.6, 0.7, 0.8, 0.9, 1, 1.1, 1.2, 1.3, 1.4, 1.5, 1.6, 1.7, 1.8, 1.9 or 2 nm in diameter.

The solution may be an aqueous solution. The solvent for the solution may comprise water. The solvent for the solution may consist essentially of water. The solution may contain no organic solvents.

The surfactant may be present at about 0.1 to about 1% w/v in the solution, or about 0.1 to 0.5, 0.1 to 0.3, 0.3 to 1, 0.5 to 1 or 0.2 to 0.5%, e.g. about 0.1, 0.15, 0.2, 0.25, 0.3, 0.35, 0.4, 0.45, 0.5, 0.6, 0.7, 0.8, 0.9 or 1%. The base may be a water soluble amine. It may be a monoalkylamine. It may be a dialkylamine. It may be a trialkylamine. It may be ammonia. It may be a mixture of the above. The alkyl group(s) on the amine, if present, may be sufficiently small that the amine is water soluble. They may for example be methyl and/or ethyl groups. The base may be a mixture of any two or more of the above bases. The base may be present in the solution at about 0.5 to 30%, or about 0.5 to 25, 0.5 to 10, 0.5 to 5, 0.5 to 2, 0.5 to 1, 1 to 25, 5 to 25, 10 to 25, 1 to 10, 1 to 5 or 5 to 10% w/v, e.g. about 0.5, 1, 1.5, 2, 2.5, 3, 3.5, 4, 4.5, 5, 6, 7, 8, 9, 10, 11, 12, 13, 14, 15, 16, 17, 18, 19, 20, 21, 23, 24, 25, 26, 27, 28, 29 or 30%. The shape of particles of the particulate mesoporous material may depend on the concentration of the base. It may depend on the pH of the solution. The mesoporous structure of the particulate mesoporous material may depend on the concentration of the base. Thus the particle morphology may be related to the mesoporous structure. The pH of the solution may be about 10 to about 13, or about 10 to 12, 10 to 11, 11 to 13, 12 to 13 or 11 to 12, e.g. about 10, 10.5, 11, 11.5, 12, 12.5 or 13.

The table below describes the morphologies and structures that were obtained in the experiments described herein:

| wt % NH₃ | Particle shape | Structure | Experiment no. |
|---|---|---|---|
| 25 | Approximately | cubic Ia 3̅d | IBN6 |
| | spherical | | |
| 15 | Irregular | 2D hexagonal p6mm | IBN7 |
| 2.5 | nanofibres | cubic Pm 3̅n | IBN8 |
| 1 | nanofibres | 3D hexagonal P6₃/mmc | IBN9 |

In an embodiment, the concentration of the base is less than about 2.5% w/v, or less than about 2, 1.5 or 1% so as to obtain mesoporous nanofibres. In this embodiment, the base (e.g. ammonia) may be present at about 0.5 to about 2.5%, or about 0.5 to 2, 0.5 to 1.5, 0.5 to 1, 1 to 2.5, 1 to 2%, e.g. about 0.5, 1, 1.5, 2 or 2.5%. Mesoporous nanofibres may in some cases be obtained using concentrations of about 0.5 to 5% base, or 1 to 5, 2.5 to 5, 1 to 3 or 2 to 4%, e.g. about 3, 3.5, 4, 4.5 or 5%.

The hydrolysable precursor may be a hydrolysable ceramic precursor. It may comprise a hydrolysable silica precursor. It may comprise a hydrolysable titania precursor in addition to the hydrolysable silica precursor. It may comprise a hydrolysable zirconia precursor in addition to the hydrolysable silica precursor. It may comprise a hydrolysable alumina precursor in addition to the hydrolysable silica precursor. It may comprise a hydrolysable iron oxide precursor in addition to the hydrolysable silica precursor. It may comprise a mixture of any two or all of a hydrolysable alumina precursor, a hydrolysable titania precursor, a hydrolysable iron oxide precursor and a hydrolysable zirconia precursor in addition to the hydrolysable silica precursor. It may for example comprise, or consist essentially of, a tetraorganosilicate, e.g. a tetraalkoxysilane. It may comprise, or consist essentially of, an organotriorganooxy silane, e.g. an alkyltrialkoxysilane or an aryltrialkoxysilane. It may additionally comprise a tetraorganotitanate, e.g. a tetraalkyltitanate. It may comprise a tetraorganozirconate, e.g. a tetraalkylzirconate. In the above compounds, each of the organo groups may independently be alkyl, aryl or some other organo group. They may be optionally substituted. They may for example be alkyl (e.g. C1 to C6 alkyl), phenyl or some other suitable group. The resultant mesoporous material may be a ceramic, e.g. silica, or an organosilica. It may be a mixed ceramic (e.g. a mixed oxide of silicon and zirconium, or of silicon and titanium, or of silicon, titanium and zirconium, optionally with organo substituents). In an embodiment the precursor is a tetraalkoxysilane, e.g. tetraethoxysilane or tetramethoxysilane, whereby the mesoporous material is mesoporous silica. The hydrolysable precursor may be hydrolysable to form a hydrolysed precursor that is capable of polymerising. It may be hydrolysable to form a hydrolysed precursor that is capable of condensing. It may be hydrolysable to form a hydrolysed precursor that is capable of polymerising under the conditions of the hydrolysis. It may be hydrolysable to form a hydrolysed precursor that is capable of condensing under the conditions of the hydrolysis. The hydrolysable precursor may be hydrolysable to form a hydrolysed precursor that is capable of polymerising or condensing to form the mesoporous material. The polymerising, or the condensing, described above may be a condensation polymerisation. In the event that the hydrolysable precursor comprises a hydrolysable silica precursor together with another hydrolysable precursor, the hydrolysable silica precursor may comprise, on a molar basis, at least about 50% of the total precursor, or at least about 60, 70, 80, 90 or 95%, or about 50 to 90, 70 to 90, 50 to 70 or 90 to 95%, e.g. about 50, 60, 70, 80, 90, 95, 96, 97, 98 or 99%. The resulting ceramic may therefore be regarded as a doped silica. The dopant in the doped silica may be one or more of titanium, zirconium, aluminium or iron, or may be some other metal.

The hydrolysable precursor may be added in a quantity about 2 to about 10 times that of the surfactant by weight, or about 2 to 5, 5 to 10, 3 to 7 or 3 to 5 times, e.g. about is 2, 3, 4, 5, 6, 7, 8, 9 or 10 times. It may be added dropwise. It may be added without agitation or with minimal agitation of the solution. It may be added over about 1 to about 30 seconds, or about 5 to 30, 10 to 30, 1 to 20, 1 to 10, 1 to 5, 5 to 20 or 5 to 10 seconds, e.g. about 1, 2, 3, 4, 5, 10, 15, 20, 25 or 30 seconds.

The process may comprise preparing the solution of the surfactant and the base. This may be achieved by dissolving the required amount of the surfactant in an aqueous solution of the base (e.g. in an ammonia solution of the desired concentration).

The surfactant may be such that the concentration of the base in the solution controls the shape of particles of the particulate mesoporous material and/or the mesoporous structure of the particulate mesoporous material. It may have a relatively large head group, so as to encourage the mesophase to adopt a high curvature. It may have a relatively large tail group, so as to encourage the mesophase to adopt a low curvature. It may be capable of varying its head to tail ratio depending on the concentration of base in solution (or depending on the pH of the solution).

The surfactant may comprise a triorganoammonium head group. The organo groups of the head group may independently be aryl (e.g. phenyl) or alkyl. They alkyl group(s) if present may short chain alkyl groups, e.g. C1 to C6 alkyl groups such as methyl, ethyl, propyl, isopropyl, etc. The head group may for example be trimethylammonium, triethylammonium, ethyltrimethylammonium or methyltriethylammonium.

The tail group may comprise an aryl group and a long chain alkyl group which is not attached directly to the aryl group. The aryl group may be an optionally substituted phenyl group or it may be an optionally substituted naphthyl group. The long chain alkyl group may be C8 to C18, or C8 to C16, C8 to C14, C12 to C18, C14 to C18 or C12 to C16, e.g. C8, C10, C12, C14, C16 or C18. As the alkyl groups may be derived from natural products, these carbon chain lengths may represent the average, or the predominant, chain length in a distribution of chain lengths. For example a C18 alkyl chain may in fact comprise C16, C17, C18, C19 and C20 in differing amounts where C18 is the predominant chain length. The long chain alkyl group may be present as an amide group. It may be present as an ester group. It may be present as a thioester group. Thus the tail group may for example be a 1-(1-alkylcarbornyl-2-arylethyl) group wherein the alkyl group is 8 to 18 carbon atoms in length.

The surfactant may be chiral. It may be derived from a natural product. It may for example be derived from an amino acid such as phenylalanine. It may be a long chain alkyl amide of the C terminus of the phenylalanine in which the N terminus has been quaternised. The amino acid from which the surfactant is derived may be the natural stereochemistry or it may be the opposite stereochemistry. It may be S. It may be R. It may be dextrorotatory or it may be levorotatory. The surfactant may be a (1-tetradecylcarbornyl-2-phenyl-ethyl)-dimethyl-ethyl-ammonium halide, for example (S)-(1-tetradecylcarbornyl-2-phenyl-ethyl)-dimethyl-ethyl-ammonium bromide.

The reaction to form the mesoporous material may be conducted (by allowing the mixture to stand without external agitation, or under static conditions) at a suitable temperature and for a suitable time for formation of the mesoporous material. The temperature may be about 20 to about 80° C., or about 20 to 60, 20 to 40, 40 to 80, 60 to 80 or 40 to 60° C., e.g. about 20, 25, 30, 35, 40, 45, 50, 55, 60, 65, 70, 75 or 80° C. The time will depend on the temperature used. It may depend on the concentration of base used. It may for example be about 12 to about 48 hours, or about 12 to 24, 24 to 48 or 18 to 30 hours, e.g. about 12, 18, 24, 30, 36, 42 or 48 hours.

As the reaction proceeds the precursor is hydrolysed. In the case of an alkoxysilane precursor for example, the hydrolysis generates a silanol species. The resulting hydrolysed precursor (e.g. the silanol species) then polymerises or condenses to form the mesoporous material. Thus the precursor may be hydrolysable to form a species which is capable of polymerising to form the mesoporous structure. Preferably it is polymerisable/condensable under the conditions of the hydrolysis of the precursor so as to form the mesoporous material. In this way, the hydrolysis and subsequent polymerisation/condensation can occur without changing conditions.

In order to obtain the structures described herein, it is important that the reaction mixture not be agitated during the conduct of the reaction, i.e. during the time over which the mesoporous material is forming. Thus the solution of the surfactant and base should not be stirred or shaken while the precursor is being added. The precursor may be added at approximately the same location on the surface of the solution, or may be added at different locations on the surface of the solution. It may be added dropwise. It may be added neat. The term “not agitated” may connote unstirred, unshaken, undisturbed etc. It will be understood that a certain degree of agitation will be likely due to disturbance during physical addition of the precursor, possible thermal effects as the precursor mixes with the solution, air currents above the solution and other spontaneous forms of agitation etc. Such unintentional forms of agitation are not excluded herein by the term “not agitated”. The lack of agitation should extend until the mesoporous material has been formed. Similarly, it is preferable that the precursor be added to the solution (to form the mixture) without agitating the solution. It will be understood that the physical act of adding the precursor will provide some small degree of agitation, however in the present context this should be ignored: the term “without agitating” and similar terms used herein should be taken to refer to encompass the minimal agitation that inevitably occurs, and should be taken to refer to the absence of additional or intentional agitation. For example, the precursor may be added dropwise, with the drops being added from only a small height above the surface of the solution (e.g. less than about 1 cm, or less than about 0.5 or 0.2 cm) rather than being dropped into the solution from a greater height.

Following formation of the mesoporous material, it may be separated from the reaction mixture. This may comprise settling, filtering, centrifuging or some other suitable method or may comprise a combination of these. It may then be washed, commonly with water. It may then be dried. This may be at elevated temperature or at room temperature. It may be at a temperature at which the material is not substantially decomposed. It may be at a temperature at which the material is stable. It may for example be between about 20 and about 100° C., although it may in some cases be higher than 100° C. The drying may additionally or alternatively comprise applying a vacuum to the material. It may comprise passing a stream of gas, optionally dry gas (e.g. nitrogen, air, carbon dioxide etc.) through and/or over the material. The drying may comprise freeze-drying. The material may be calcined so as to remove the surfactant. The calcining may be at a temperature of about 500 to about 1000° C., or about 500 to 800, 500 to 600, 600 to 1000, 800 to 1000 or 550 to 650° C., e.g. about 500, 550, 600, 650, 700, 750, 800, 850, 900, 950 or 1000° C. The time for the calcining may depend on the temperature used. It may be for example about 3 to about 12 hours, or about 3 to 6, 6 to 12 or 4 to 8 hours, e.g. about 3, 4, 5, 6, 7, 8, 9, 10, 11 or 12 hours.

Also disclosed herein is a particulate mesoporous material. It may be in the form of nanoparticles, e.g. nanofibres. The mesoporous material may be a mesoporous ceramic material. It may be a mesoporous organoceramic material. It may for example comprise, or consist essentially of, mesoporous silica, optionally comprising one or more of titania structures, alumina structures, iron oxide structures and zirconia structures. It may comprise, or consist essentially of, mesoporous silica, optionally doped with one or more of titanium, zirconium, iron or aluminium. It may comprise titanium doped silica. It may comprise zirconium doped silica. It may comprise iron doped silica. It may comprise aluminium doped silica.

The nanofibres (or acicular nanoparticles) may have a cubic Pm 3̅n or 3D hexagonal P6₃/mmc mesophase. They may have a length to diameter ratio of about 20 to about 500, or about 50 to 500, 100 to 500, 200 to 500, 10 to 200, 20 to 100, 20 to 50, 50 to 200 or 100 to 200, e.g. about 20, 30, 40, 50, 100, 150, 200, 250, 300, 350, 400, 450 or 500. They may have a mean diameter of about 50 to about 500 nm, or about 50 to 200, 50 to 100, 100 to 500, 200 to 500 or 100 to 300 nm, e.g. about 50, 100, 150, 200, 250, 300, 350, 400, 450 or 500 nm. They may have a mean length of about 5 to about 100 microns, or about 5 to 50, 5 to 20, 5 to 10, 10 to 50, 20 to 50 or 10 to 30 microns, e.g. about 5, 10, 15, 20, 25, 30, 35, 40, 45 or 50 microns. They may have a mean BJH pore size of 1 to 10 nm.

The nanoparticles may be substantially spherical, or may be irregular shaped, or may be acicular. They may be off-round. They may be somewhat cubic, or somewhat pyramidal, commonly with rounded corners and edges. The nanoparticles may have a mean diameter of about 100 to about 1000 nm, or about 100 to 500, 100 to 200, 200 to 1000, 500 to 1000 or 200 to 500 nm, e.g. about 100, 150, 200, 250, 300, 350, 400, 450, 500, 550, 600, 650, 700, 750, 800, 850, 900, 950 or 1000 nm. They may have a broad particle size distribution. They may have a narrow particle size distribution.

The nanoparticles and the nanofibres may independently (as measured by N₂ sorption isotherm analysis) have a BET surface area of about 500 to about 1000 m²/g, or about 500 to 750, 750 to 1000, 600 to 800, 700 to 900 or 800 to 900 m²/g, e.g. about 500, 550, 600, 650, 700, 750, 800, 850, 900, 950 or 1000 m²/g. They may have a BJH (Brunauer-Joyner-Halenda) average pore size of about 1 to about 5 nm, or about 1 to 3, 3 to 5 or 2 to 4 nm, e.g. about 1, 1.5, 2, 2.5, 3, 3.5, 4, 4.5 or 5 nm. They may have a pore volume (specific pore volume) of about 0.5 to about 1 cm³/g or about 0.5 to 0.8, 0.7 to 1 or 0.6 to 0.8 cm³/g, e.g. about 0.5, 0.55, 0.6, 0.65, 0.7, 0.75, 0.8, 0.85, 0.9, 0.95 or 1 cm³/g. They may have a pore volume fraction of about 40 to about 80%, or about 40 to 60, 60 to 80 or 50 to 70%, e.g. about 40, 45, 50, 55, 60, 65, 70, 75 or 80%.

The surfactant described earlier for use in the present invention may be made by quaternising the corresponding tertiary amine. The quaternising may be performed by means of a short chain alkyl halide. The halide may be chloride, bromide or iodide. The short chain alkyl group may for example be methyl, ethyl, propyl or isopropyl. It may be a C1 to C6 alkyl group. It may be straight chain or (if greater than C2) branched. The short chain alkyl halide is commonly used in a substantial molar excess relative to the tertiary amine. The tertiary amine may comprise the tail group of the surfactant (as described earlier) attached to a dialkylamino group. The alkyls of the dialkylamino group may be short chain alkyls. They may for example be (independently) methyl, ethyl, propyl or isopropyl. They may be C1 to C6 alkyl groups. They may be straight chain or (if greater than C2) branched. They may be the same or they may be different. The tertiary amine may be an N,N-dialkylated amino acid (e.g. phenylalanine) in which the C terminus has been converted to an amide or ester of a long chain (e.g. C8 to C18) amine (or alcohol). The quaternisation reaction may be conducted in a suitable solvent, e.g. a polar solvent such as acetonitrile, acetone etc. It may be conducted at a temperature of about 50 to about 100° C., and preferably at or below the boiling point of the solvent. It may, depending on the solvent, be conducted at about 50 to 75, 75 to 100 or 60 to 80° C., e.g. about 50, 55, 60, 65, 70, 75, 80, 85, 90, 95 or 100° C. The time required may depend on the temperature of the reaction, and may be for example about 6 to about 24 hours, or about 6 to 12, 12 to 24 or 9 to 15 hours, e.g. about 6, 9, 12, 15, 18, 21 or 24 hours.

The surfactant may in a particular example comprise a quaternary ammonium group coupled to a tail group, said tail group being a 1-(1-alkylcarbornyl-2-arylethyl) group wherein the alkyl group is 8 to 18 carbon atoms in length. In this case the corresponding tertiary amine used to make the surfactant may be a dialkylamino group coupled to the 1-(1-alkylcarbornyl-2-arylethyl) group. In this case, the tertiary amine may be made by reacting an N,N-dialkyl-arylalanine, e.g. N,N-dialkyl-phenylalanine, (wherein the alkyl groups are short chain alkyl groups) with a long chain alkyl primary amine so as to form the tertiary amine. The alkyl group of the long chain primary alkyl amine may be a C8 to C18 alkyl group as described previously. The formation of the amide group to form the tertiary amine described earlier may comprise known amide forming reactions. A suitable reaction involves exposing the N,N-dialkyl-arylalanine and the long chain primary alkyl amine to N,N′-dicyclohexylcarbodiimide (DCC) or other similar dehydration agent. Commonly the reaction is conducted in a polar aprotic solvent such as dichloromethane, chloroform etc. and the reagents are all in approximately equimolar amounts. 1-Hydroxybenzotriazole hydrate may also be used as a core agent, commonly in excess, e.g. roughly twofold molar excess, over the alkyl amine. The reaction may be conducted in a solvent, e.g. a polar solvent such as acetonitrile, acetone, diethyl ether etc. It is commonly conducted at room temperature, and may conveniently be conducted at about 10 to about 30° C., or about 10 to 20, 20 to 30 or 15 to 25° C., e.g. about 10, 15, 20, 25 or 30° C. The reaction time may depend on the temperature. It may be 6 to about 24 hours, is or about 6 to 12, 12 to 24 or 9 to 15 hours, e.g. about 6, 9, 12, 13, 14, 15, 18, 21 or 24 hours.

Any of the reactions described above may be conducted in an atmosphere of air, or may be conducted under nitrogen, carbon dioxide, helium or some other suitable atmosphere if required.

The mesoporous materials, e.g. the mesoporous nanofibres, described herein may be suitable for use as a waveguide or as a laser material or in catalytic, sensing, controlled release, drug delivery, separation, electrochemical or optical applications.

### BRIEF DESCRIPTION OF THE DRAWINGS

Preferred embodiments of the present invention will now be described, by way of example only, with reference to the accompanying drawings wherein:

FIG. 1 shows (a-d) XRD patterns and (e-h) N₂ adsorption-desorption isotherms of mesoporous silica materials synthesized in ammonia solution concentrations of (a,e) 25 wt % (IBN-6), (b,f) 15 wt % (IBN-7), (c,g) 2.5 wt % (IBN-8), and (d,h) 1.0 wt % (IBN-9).

FIG. 2 shows TEM images of IBN-6 synthesized in 25 wt % of ammonia solution (cubic Ia 3̅d): (a) Low-magnification TEM image; (b-d) HRTEM images taken at different incidences: (b) [111], (c) [110], and (d) [100]. Insets are the FT diffractograms.

FIG. 3 shows TEM images of IBN-8 synthesized in 2.5 wt % of ammonia solution (cubic Pm 3̅n): (a) low-magnification TEM image. HRTEM images taken at different incidences, (b) [110], (c) [100], and (d) [210]. Insets are the FT diffractograms.

FIG. 4 shows TEM images of IBN-9 synthesized in 1.0 wt % of ammonia solution (3D hexagonal P6₃/mmc): (a,b) low-magnification images; (c) HRTEM image of square 1 marked in FIG. 4b taken at [100] incidence. Inset is the corresponding FT diffractogram. The HRTEM images of squares 2-4 marked in FIG. 4b are shown in FIG. 8.

FIG. 5 is a TEM image of an IBN-9 fiber with (a) a contracted hcp structure (c/a=1.61), and (b) an elongated hcp structure (c/a=1.75). The TEM images are taken at [100] incidence, and their FT diffractograms are shown in the insets.

FIG. 6 is SEM image of IBN-6 (cubic Ia 3̅d) synthesized with surfactant 2 in 25 wt % of ammonia solution.

FIG. 7 is an SEM image of IBN-7 (2D hexagonal p6 mm) synthesized with surfactant 2 in 15 wt % of ammonia solution.

FIG. 8 shows HRTEM images of (a) square 1, (b) square 2, (c) square 3, and (d) square 4 marked on the ISN-9 fibre in FIG. 4b.

FIG. 9 shows SEM images and N₂ adsorption-desorption isotherms of a,c, IBN-9 and b,d, IBN-6. Insets in c and d are the corresponding pore size distributions.

FIG. 10 shows HRTEM images of IBN-9 nanofibers taken along different zone axes. The pore structure is highly ordered over the entire crystal. The HRTEM image along the [001] direction was taken from an ultra-thin slice of a nanofiber cut by microtome. Scale bar=50 nm.

FIG. 11 shows SEM images of IBN-9 synthesized at different conditions: a, in 10 wt % ammonia solution, and b, in 5 wt % ammonia solution.

FIG. 12 shows HRTEM images and XRD pattern of IBN-6. HRTEM image taken along a, the [111] zone axis; b, the [110] zone axis; c, the [100] zone axis. Insets are the corresponding Fourier transforms. d, XRD pattern. Note: Reflection conditions were determined as hkl: h+k+l=2n; Okl: k, l=2n; hhl: 2h+l=4n; h00: h=4n. The projection symmetries along the [111], [110] and [100] directions were determined as p6 mm, cmm and p4 mm from the HRTEM images, respectively, with average phase errors less than 10°. The space group was determined as Ia-3d (No. 230) by combining the reflection conditions and projection symmetries.

FIG. 13 shows representations of the 3D pore structure of IBN-6. a, The 3D pore structure reconstructed from the HRTEM images taken along the three different zone axes (FIG. 12), showing the bi-continuous gyroidal channel systems. b, An enantiomorphic pair of the three-coordinated srs net (blue: vertically down, upper left and upper right; and red: vertically up, lower left and lower right), representing the two gyroidal channels in IBN-6.

FIG. 14 shows a TEM image and XRD pattern of IBN-10. a, TEM image. b, XRD pattern.

### DETAILED DESCRIPTION OF THE PREFERRED EMBODIMENTS

A novel amino acid-based surfactant has been designed and synthesized. Using this surfactant as template, four different mesophases, cubic Ia 3̅d, two-dimensional (2D) hexagonal p6 mm, cubic Pm 3̅n and three-dimensional (3D) hexagonal P6₃/mmc, have been prepared in ammonia solution. The type of mesophase is determined by the concentration of the ammonia solution. The cubic Pm 3̅n and hexagonal P6₃/mmc phases exhibit novel nanofibre morphology. Unlike the previously reported mesoporous silica fibres with one-dimensional (1D) channel-like pores, the fibres of the present invention display highly ordered mesostructures with three-dimensionally connected cage-like pores. They exhibit highly ordered mesostructures with three-dimensionally connected cage-like pores. Fibres with 3D porous structure have not been reported before. Transmission electron microscopy (TEM) studies demonstrate that the fibres have excellent long-range structure ordering. It is proposed that the static synthesis condition and the low ammonia solution concentration are important for the spontaneous growth of mesoporous silica nanofibres.

Compared to conventional silica fibres with 1D pores, the fibres described herein possess a more open and regular pore structure that is interconnected. This renders them more attractive for catalytic, sensing, separation, electrochemical and optical applications.

### Example 1

### Experimental Section

### Synthesis of amino acid-based cationic surfactant (S)-(1-tetradecylcarbornyl-2-phenyl-ethyl)-dimethyl-ethyl-ammonium bromide (surfactant 2)

Surfactant 2 was synthesized from N,N-dimethyl-L-phenylalanine in two steps as outlined in Scheme 1. The alkyl chain was introduced via N,N′-dicyclohexylcarbodiimide/1-hydroxybenzotriazole hydrate (DCC/HOBt) coupling with tetradecylamine in 85% yield after column chromatography. Ethylation of the amide derivative 1 with bromoethane in acetonitrile at 75° C. produced surfactant 2 in quantitative yield. Compound 2 was characterized by ¹H NMR spectroscopy.

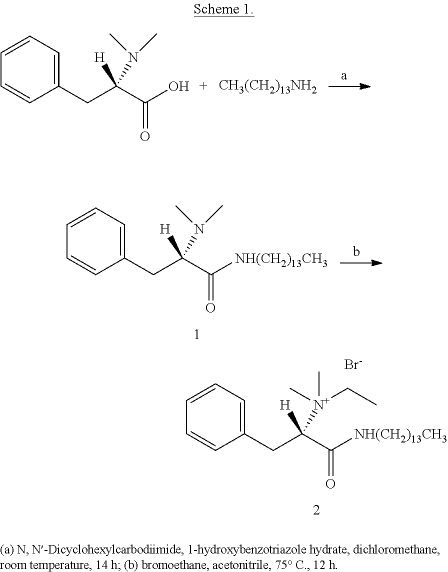

Materials. Silica gel 60 (230-400 mesh, Merck) was used for column chromatography. The solvents for the synthesis were of reagent grade and used as-received. All other reagents were purchased from Aldrich, Fluka and Merck, and used as-received. All synthesized compounds were characterized using ¹H NMR spectroscopy.

Physical Measurements. ¹H NMR spectra were collected in CDCl₃ using a Bruker AV-400 (400 MHz) spectrometer at 25° C. Chemical shifts were reported in ppm from tetramethylsilane with the solvent resonance as the internal standard.

(S)-2-(dimethylamino)-3-phenyl-N-tetradecylpropanamide (1). A solution of N,N-dimethyl-L-phenylalanine (2.50 g, 12.9 mmol), tetradecylamine (3.04 g, 14.2 mmol), N,N′-dicyclohexylcarbodiimide (2.89 g, 14.0 mmol) and 1-hydroxybenzotriazole hydrate (3.32 g) in dichloromethane (250 mL) was stirred at room temperature in air for 14 h. The reaction mixture was washed with 10% aqueous NaHCO₃ (2×200 mL). The organic layer was separated and dried over Na₂SO₄, and the solvent was removed by rotary evaporation. Purification by column chromatography (silica gel, ethyl acetate) produced 1 as a white solid (4.26 g, 85%). ¹H NMR (400 MHz, CDCl₃, 25° C.): δ=7.27-7.15 (m, 5H), 6.75 (t, J=5.15 Hz, 1H), 3.25-3.11 (m, 4H), 2.91-2.85 (m, 1H), 2.31 (s, 6H), 1.45-1.25 (m, 24H), 0.89 (t, J=6.86 Hz, 3H).

(S)-(1-Tetradecylcarbomyl-2-phenyl-ethyl)-dimethyl-ethyl-ammonium bromide (2). A solution of 1 (1.00 g, 2.57 mmol) and bromoethane (11.9 mL, 17.37 g, 159.40 mmol) in acetonitrile was heated at 75° C. in air for 12 h. The solvent was removed by rotary evaporation to give 2 as a white sticky solid in quantitative yield (1.28 g). ¹H NMR (400 MHz, CDCl₃, 25° C.): δ=8.57 (t, J=5.60 Hz, 1H), 7.40-7.25 (m, 5H), 5.90 (t, J=7.94 Hz, 1H), 4.11-4.02 (m, 1H), 3.73-3.64 (m, 1H), 3.36 (s, 3H), 3.33 (s, 3H), 3.26 (d, J=8.09 Hz, 2H), 3.16-3.07 (m, 1H), 2.94-2.85 (m, 1H), 1.52 (t, J=7.26 Hz, 3H), 1.31-0.99 (m, 24H), 0.88 (t, J=6.86 Hz, 3H).

### Synthesis of Nanostructures

In a typical synthesis of mesoporous nanofibres with 3D hexagonal P6₃/mmc structure, 35 mg of surfactant 2 were dissolved in 10 mL of aqueous ammonia solution (1.0 wt %) at 50° C. Next, 0.15 mL of TEOS was added dropwise under a static condition (i.e. without stirring). The mixture was reacted at 50° C. for 24 h under a static condition to produce white flocculates (mesoporous silica fibres) in the solution. The flocculates were collected, washed with water, dried in air, and calcined at 550° C. for 5 h to remove the organic template. The other three samples with cubic Ia 3̅d, 2D hexagonal p6 mm and cubic Pm 3̅n were synthesized in 25 wt %, 15 wt % and 2.5 wt % of ammonia solution, respectively, without changing the other synthesis parameters. In the cases of cubic Ia 3̅d and 2D hexagonal p6 mm, however, white precipitates instead of flocculates were formed in the solution.

TEM was performed on a FEI Tecnai G² F20 electron microscope operated at 200 kV with the software package for automated electron tomography. SEM was performed on a JEOL JSM-7400F electron microscope. XRD patterns were obtained with a Siemens D5005 diffractometer. Nitrogen sorption isotherms were obtained using a Micromeritics ASAP 2020M system.

### Discussion

The present disclosure describes the use of a novel amino acid-based cationic surfactant, (S)-(1-tetradecylcarbornyl-2-phenyl-ethyl)-dimethyl-ethyl-ammonium bromide (surfactant 2 in Scheme 1), as the template. This specially designed surfactant successfully induced the formation of four different types of mesophases, cubic Ia 3̅d, 2D hexagonal p6 mm, cubic Pm 3̅n and 3D hexagonal P6₃/mmc, with decreasing ammonia solution concentration from 25 wt % to 1.0 wt %. The cubic Ia 3̅d mesophase consisted of submicron-sized particles with well-defined single crystal morphology. The cubic Pm 3̅n and hexagonal P6₃/mmc phases were composed of long fibres (5-30 μm) with diameters of 60-300 nm. Unlike the conventional approaches of fibre drawing from viscous gel and fibre growth within a confined space, the present synthesis provides a spontaneous growth of mesoporous nanofibres in solution. A few approaches have been reported before on the growth of mesoporous fibres in an acidic solution. However, all of the fibres obtained showed one-dimensional (1D) channels either parallel to or concentrically circling around the fibre axis. In contrast, the fibres described herein were fabricated in a basic medium, and exhibited highly ordered mesostructures with three-dimensionally connected cage-like pores.

Surfactant 2 was synthesized from N,N-dimethyl-L-phenylalanine in two steps as outlined in Scheme 1. Compared to the commonly used alkyltrimethylammonium surfactants, surfactant 2 has a larger head group (aₒ) that favors the formation of mesophase with high surface curvature, e.g. cubic Pm 3̅n or hexagonal P6₃/mmc. On the other hand, it has a hydrophobic (phenyl) side group that tends to enter the hydrophilic-hydrophobic “palisade” region of the micelle, increasing the volume of the hydrophobic core (V). This would facilitate the formation of mesophase with a low surface curvature, e.g. cubic Ia 3̅d. The combination of these two opposing effects in surfactant 2 might be responsible for its flexibility in inducing various mesophases under different conditions.

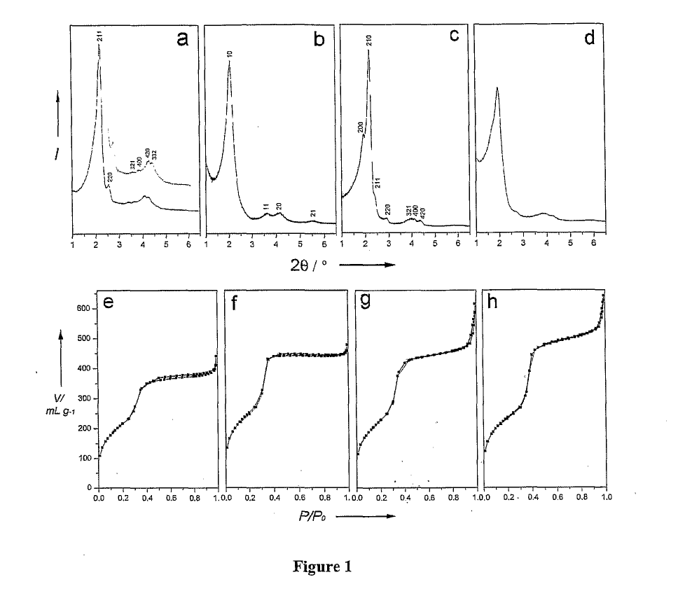

FIG. 1a shows the X-ray diffraction (XRD) pattern of the sample synthesized in 25 wt % of ammonia solution (pH=13.2). The diffraction peaks observed was indexed to a cubic system with lattice constant a=107.5 Å. N₂ sorption isotherm analysis (FIG. 1e) indicated a BET surface area of 860 m²/g, a BJH average pore size of 2.7 nm and a pore volume of 0.63 cm³/g for this sample (Table 1).

TABLE 1
Mesoporous silica materials synthesized with surfactant 2 in ammonia solution.

| | Ammonia | | | BET | Pore | Pore |
|---|---|---|---|---|---|---|
| | Concentration | | | Surface | Volume | Size |
| Sample | (wt %) | Mesostructure | Morphology | Area (m²/g) | (cm³/g)* | (nm)† |
| IBN-6 | 25 | 3D Cubic | Single | 860 | 0.63 | 2.7 |
| | | (Ia 3̅d) | Crystal | | | |
| IBN-7 | 15 | 2D Hexagonal | Irregular | 921 | 0.69 | 2.9 |
| | | (p6mm) | | | | |
| IBN-8 | 2.5 | 3D Cubic | Nanofibers | 842 | 0.75 | 2.8 |
| | | (Pm 3̅n) | | | | |
| IBN-9 | 1.0 | 3D Hexagonal | Nanofibers | 861 | 0.82 | 3.1 |
| | | (P6₃/mmc) | | | | |

*Single-point adsorption pore volume at P/P₀ = 0.95. The textural pore volume is not included.
^{†}Calculated from the adsorption branch of the N₂ sorption isotherm using the BJH method.

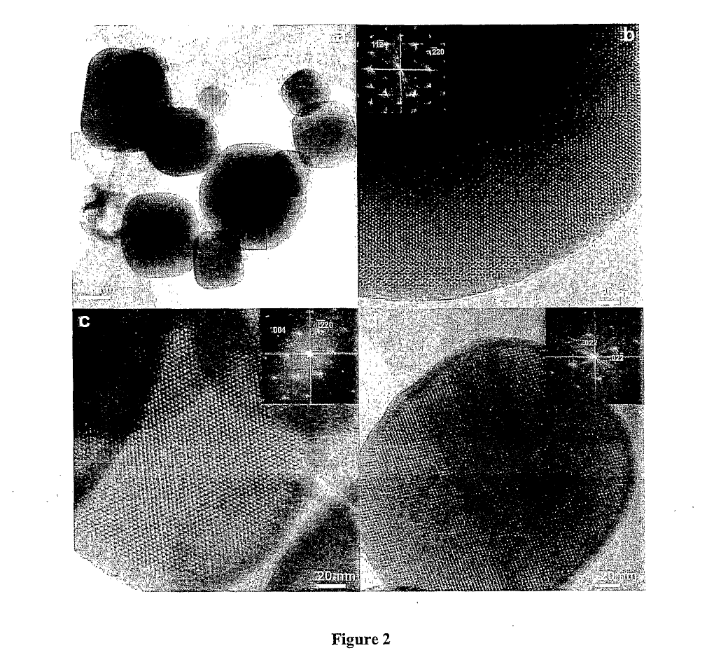

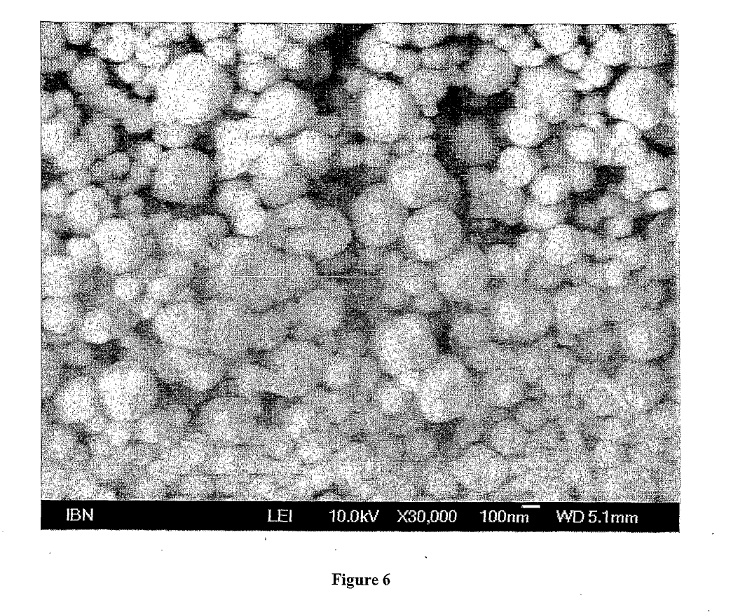

Scanning electron microscopy (SEM) images reveal that this sample (IBN-6) consists of submicron-sized particles (200-700 nm) with single crystal-like morphologies that are in good accordance with their cubic symmetry (FIG. 6). The low-magnification transmission electron microscopy (TEM) image confirms the well-defined particle morphology (FIG. 2a). The edge of a hexagonal particle marked in FIG. 2a is magnified as FIG. 2b, which shows the typical TEM image of a cubic Ia 3̅d mesophase taken at [111] incidence. FIGS. 2c and 2d are the high-resolution TEM (HRTEM) images taken from other particles at [110] and [100] incidences, respectively. The corresponding Fourier-transform (FT) diffractograms exhibited reflection conditions that were well consistent with Ia 3̅d symmetry (insets of FIGS. 2b-d).

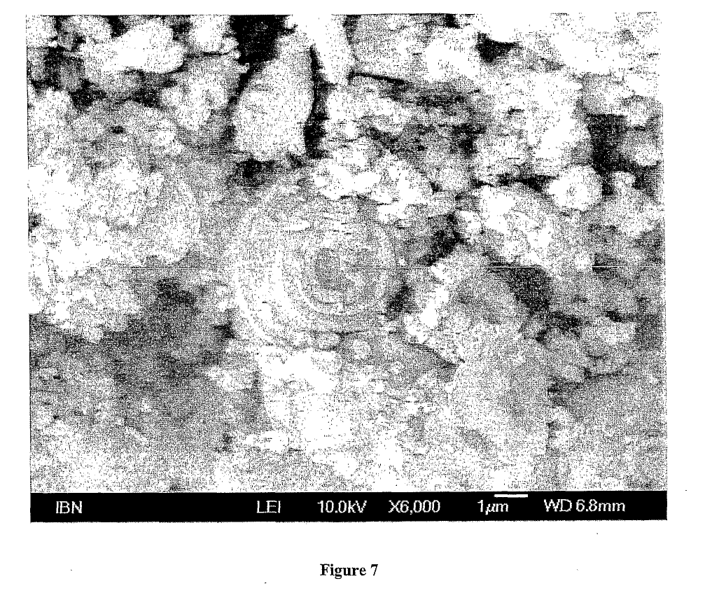

The sample synthesized in 15 wt % of ammonia solution (pH=12.6) has a 2D to hexagonal p6 mm mesostructure as indicated by the XRD pattern (FIG. 1b). This sample (IBN-7) shows irregular particle morphology (FIG. 7). Its textural properties determined from the N₂ sorption isotherm analysis (FIG. 1f) are presented in Table 1.

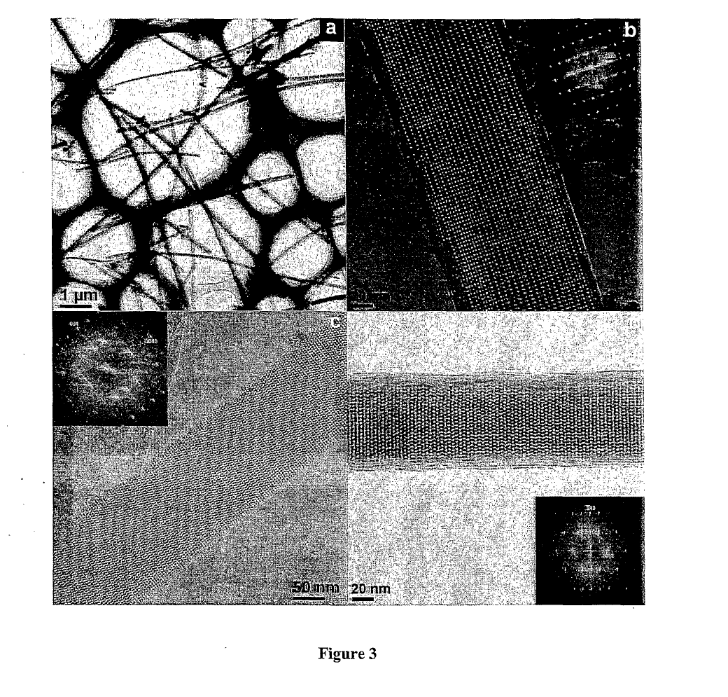

When the ammonia concentration was decreased to 2.5 wt % (pH=11.9), the material obtained (IBN-8) has a different XRD pattern from that of cubic Ia 3̅d or hexagonal p6 mm phase (FIG. 1c). The four peaks in the range of 1.8-3.0° were indexed as the (200), (210), (211) and (220) reflections, respectively, of a cubic system with lattice constant a=91.2 Å, based on their d values. The additional peaks in the range of 3.5-5° could be well indexed accordingly. IBN-8 further exhibited a unique fibre morphology, with diameters of 60-300 nm and lengths of 5-30 μm (FIG. 3a). Many individual fibres have been observed with TEM, and they all showed a highly ordered mesostructure. The HRTEM images with the [100], [110] and [210] incidences are shown in FIGS. 3b-d. Their FT diffractograms (insets) clearly showed the reflection conditions hhl where l=2n, which were in agreement with the Pm 3̅n (or P43n) space group. The lattice constant a was determined to be 90.6 Å, as consistent with the XRD findings. The results indicated that IBN-8 has a similar mesostructure as SBA-1 synthesized with cetyltriethylammonium surfactant in an acidic medium, or SBA-6 synthesized with Gemini surfactant 18B₄₋₃₋₁ in a basic medium [Q. S. Huo, D. I. Margolese, U. Ciesla, P. Y. Feng, T. E. Gier, P. Sieger, R. Leon, P. M. Petroff, F. Schiith, G. D. Stucky, Nature 1994, 368, 317; Y. Sakamoto, M. Kaneda, O. Terasaki, D. Zhao, J.-M. Kim, G. D. Stucky, H. J. Shin, R. Ryoo, Nature 2000, 408, 449]. Unlike SBA-1 and SBA-6, which showed irregular or crystal-like particle morphology, IBN-8 has a fibre morphology with a high aspect ratio. This is the first report of mesoporous fibre with cubic structure. One of the possible space group P 4̅3̅n was excluded for SBA-1 and SBA-6 based on their crystal morphologies. For the fibres described herein, however, P 4̅3̅n symmetry could not be excluded with the currently available data. IBN-8 also exhibited a type IV N₂ adsorption-desorption isotherm characteristic of mesoporous materials (FIG. 1g). Compared with the Ia 3̅d and p6 mm mesophases mentioned earlier, IBN-8 has a similar BJH pore size (2.8 nm), but a much higher pore volume (0.75 cm³/g) (Table 1). Besides the porosity from the well-defined mesopores, this sample shows significant interfibre (textural) porosity, as evidenced by the adsorption step at high relative pressures of >0.95.

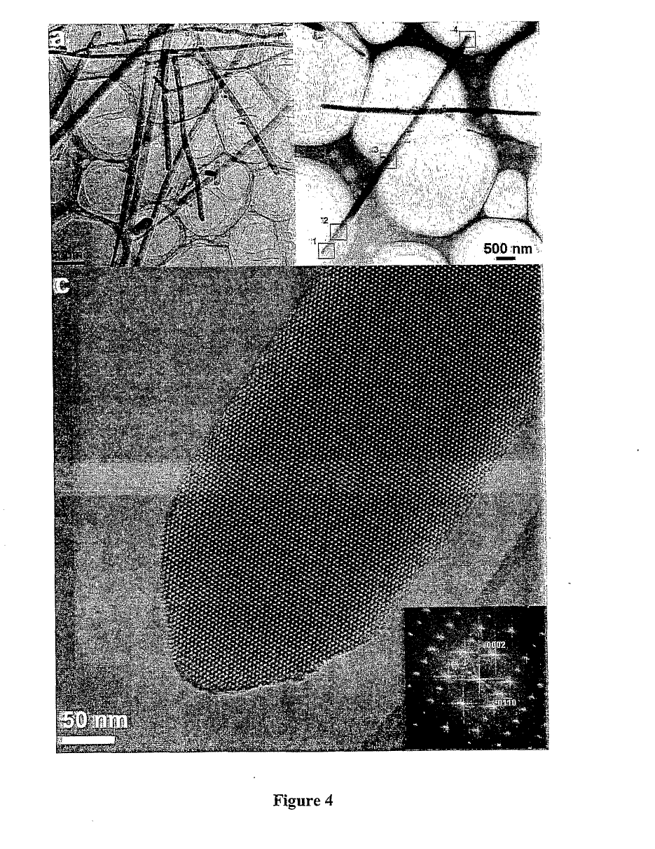

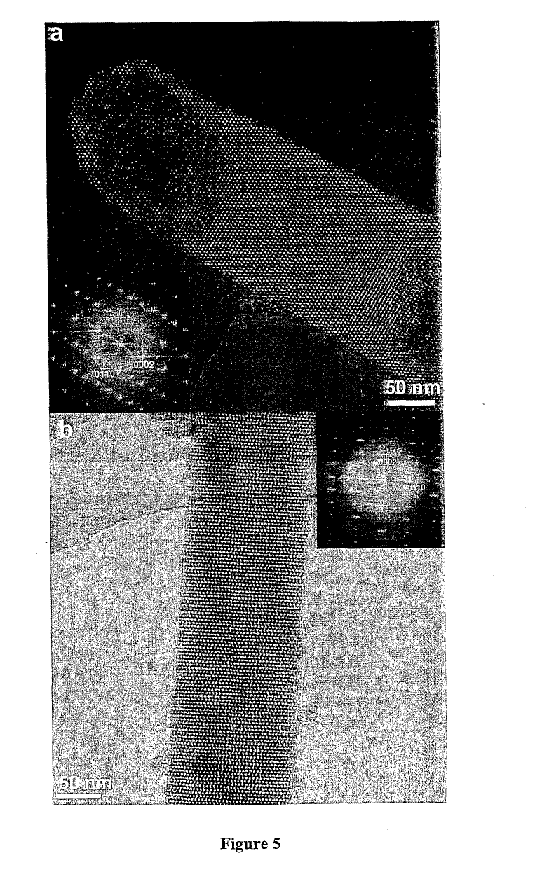

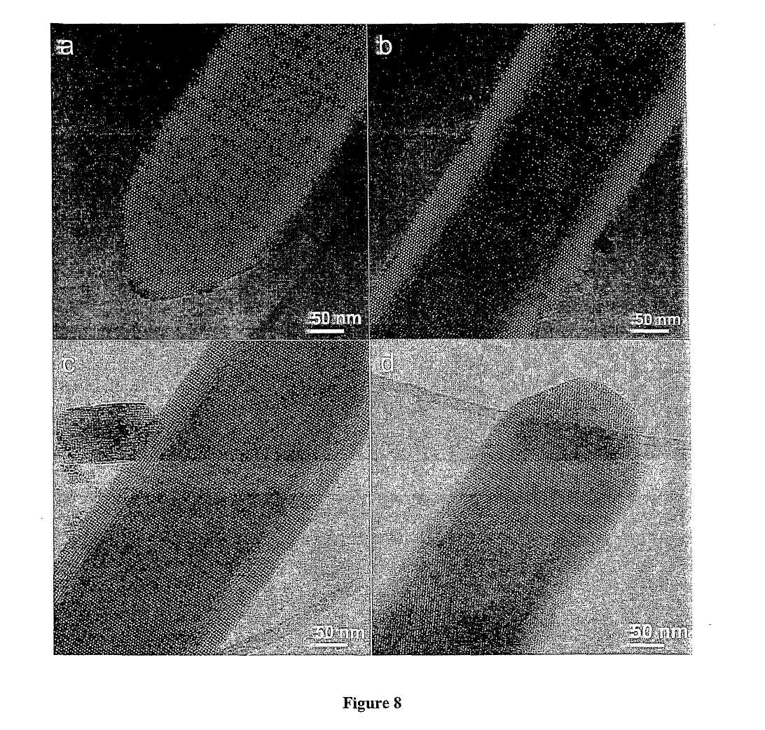

When the ammonia solution concentration was decreased to 1.0 wt % (pH=11.2), the sample obtained (IBN-9) maintained the fibre morphology (FIGS. 4a and b), but m showed less well-resolved XRD peaks, making it difficult to identify the structure (FIG. 1d). However, HRTEM image taken at the end of one fibre clearly indicated the highly ordered mesostructure (FIG. 4c), and the corresponding FT diffractogram (inset) could be well indexed to the 3D hexagonal P6₃/mmc phase at [100] incidence. The lattice constants a=47.1 Å and c=76.9 Å were calculated from the FT pattern, giving a c/a is ratio of 1.633, which was the ideal c/a ratio for the hexagonal close-packed (hcp) structure. Moreover, the stacking of the cage-like pores in the characteristic “ . . . ABABAB . . . ” sequence was clearly observed along the fibre axis (FIG. 4c). This observation confirmed the hcp structure, and suggested that the fibres were grown via the stacking of the cages along the hexagonal c-axis. A series of TEM images were obtained at different positions along the same fibre without tilting the TEM specimen (FIG. 8). They demonstrated that ordered mesostructure was present over the entire fibre, indicating the high quality of the fibre. Further study illustrated that the stacking of the cages in some fibres did not strictly follow the ideal hexagonal close packing. The c/a ratio varied from 1.61 to 1.75 in different fibres, although the a value was relatively constant (˜47.0 Å). For example, the IBN-9 fibre shown in FIG. 5a has a contracted hexagonal structure along c-axis with a c/a ratio of 1.61 (a=46.9 Å, c=75.5 Å), whereas the fibre in FIG. 5b has an elongated hexagonal structure with a c/a ratio of 1.75 (a=46.9 Å, c=81.9 Å). Thinner fibres usually showed larger c values. The variable lattice constants between different fibres might be responsible for the poor resolution of the XRD pattern (FIG. 1d). IBN-9 also possessed a particularly large pore volume (Table 1), and significant interfibre (textural) porosity as indicated in the N₂ adsorption-desorption isotherm (FIG. 1h).

The above findings illustrated the effect of ammonia solution concentration on the mesophase formation. Bicontinuous cubic Ia 3̅d mesophase was obtained in 25 wt % of ammonia solution. 2D hexagonal mesophase (p6 mm) with cylindrical pores was obtained in 15 wt % of ammonia solution. Further decreasing the ammonia solution concentration to 2.5 wt % and 1.0 wt % gave rise to cubic Pm 3̅n phase and 3D hexagonal P6₃/mmc phase, respectively, with cage-like pores. Thus, four different mesophases with pore wall curvatures ranging from low (cubic Ia 3̅d) to high (hexagonal P6₃/mmc) have been fabricated with the same surfactant (2) by simply decreasing the ammonia solution concentration. The stronger alkalinity of high-concentration ammonia solution led to higher negative charge density of the silicate species. In order to maintain a matching charge density, the surfactant molecules would adopt a more compact packing (to form less curved micelles) when they assembled with silicate species into mesophase. Moreover, the highly concentrated ammonia molecules provided a crowded environment for surfactant micelles, which would also induce a more compact packing of surfactant molecules.

Notably, the cubic Pm 3̅n and 3D hexagonal P6₃/mmc mesophases showed a unique fibre morphology that has not been reported in previous work. The key to the fibre formation in the present work appears to be to kinetically control the rate of hydrolysis of the silica species at the two-phase interface. In the present synthesis, the silica precursor tetraethoxysilane (TEOS) was added under a static condition (without stirring) to form an “oil” phase on top of the aqueous ammonia solution containing surfactant 2. Without any disturbance, TEOS was slowly hydrolyzed at the oil/water interface where the resulting silicates assembled with the surfactant molecules to nucleate the mesophase. Since more surfactants were available in the aqueous phase, the silica/surfactant composites would grow from the oil/water interface towards the aqueous solution, leading to the formation of fibres. If the synthesis was performed with continuous stirring instead of under a static condition, TEOS would be uniformly dispersed in the ammonia solution within a short time, resulting in rapid, uncontrolled silica hydrolysis/condensation with more nuclei formed. Consequently, small irregular particles were obtained. Likewise, highly concentrated ammonia solution was unfavorable for fibre morphology because of the high hydrolysis rate of TEOS at high pH. This would explain why the cubic Ia 3̅d mesophase and the hexagonal p6 mm mesophase, which were synthesized in 25 wt % and 15 wt % of ammonia solution, respectively, did not show a fibre morphology. A similar approach that utilized carefully controlled silica hydrolysis at oil/water interface to fabricate mesoporous silica fibres was reported by Huo et al. [(a) Q. S. Huo, D. Y. Zhao, J. L. Feng, K. Weston, S. K. Buratto, G. D. Stucky, S. Schacht, F. Schüth, Adv. Mater. 1997, 9, 974. (b) F. Marlow, M. D. McGehee, D. Zhao, B. F. Chmelka, G. D. Stucky, Adv. Mater. 1999, 11, 632]. In that case, alkyltrimethylammonium surfactant was used as the template, and an acidic solution (HCl) was used as the reaction medium. The resulting fibres were millimeters in length and microns in diameter containing 1D channel-like pores. In contrast, the mesoporous silica nanofibres IBN-8 and IBN-9 of the present work were much smaller in dimensions with ordered 3D cage-like pores. They possess a more open and regular pore structure, and are potentially more attractive for applications such as catalysis and sensing.

In summary, a novel amino acid-based surfactant was designed and synthesized. Using this surfactant as the template, four different mesophases, cubic Ia 3̅d, 2D hexagonal p6 mm, cubic Pm 3̅n and 3D hexagonal P6₃/mmc, have been derived. The specific mesophase was determined by the ammonia solution concentration used. The sample with cubic Ia 3̅d structure consisted of submicron particles with single crystalline morphology. The cubic Pm 3̅n and hexagonal P6₃/mmc phases exhibited novel nanofibre morphology. TEM studies demonstrated that these fibres have excellent long-range structure ordering. We proposed that the static synthesis condition and low ammonia concentration were essential for the spontaneous growth of mesoporous silica nanofibres in this system.

### Example 2

### Experimental Section

Surfactant 2 was synthesised as described in Example 1.

In a typical synthesis of IBN-9, 35 mg of surfactant 2 were dissolved in 12 mL of aqueous ammonia solution (2.0 wt %) at 50° C. Next, 0.15 mL of TEOS was added dropwise under a static condition. The mixture was heated at 50° C. for 24 h under a static condition. The white flocculates obtained were washed with water, dried in air, and calcined at 550° C. for 5 h to remove the surfactant. IBN-6 and IBN-10 were synthesized by following the same procedure as above, except that 25 wt % ammonia solution and a smaller amount of surfactant 2 (18 mg) were used in the preparation of IBN-6 and IBN-10, respectively.

TEM was performed on a JEOL 2100 LaB₆ electron microscope operated at 200 kV. SEM was performed on a JEOL JSM-7400F electron microscope operated at 15 kV. XRD patterns were obtained with a Siemens D5005 diffractometer. Nitrogen adsorption-desorption isotherms were obtained using a Micromeritics ASAP 2020M system. Pore sizes were determined by Brunauer-Joyner-Halenda (BJH) analysis of the adsorption branch.

3D reconstruction of IBN-9

The 3D electrostatic potential map of IBN-9 was obtained by combining the HRTEM images taken along [110], [1-10] and [001] directions. The structure factor amplitudes and phases (Table 2) were extracted from the Fourier transforms of the HRTEM images using the program CRISP [Hovmöller, S. CRISP: Crystallographic image processing on a personal computer. Ultramicroscopy 41, 121-135 (1992)].

TABLE 2
Amplitudes and phases of the structure factors of IBN-9.

| h | k | l | Amplitude | Phase | d (Å) |
|---|---|---|---|---|---|
| 0 | 1 | 0 | 337 | 180 | 76.56 |
| 1 | 1 | 0 | 3500 | 0 | 44.20 |
| 0 | 0 | 2 | 6293 | 0 | 42.15 |
| 2 | −1 | 1 | 4616 | 180 | 39.15 |
| 0 | 2 | 0 | 10000 | 180 | 38.28 |
| 0 | 1 | 2 | 3618 | 0 | 36.92 |
| 2 | −1 | 2 | 395 | 0 | 30.50 |
| 1 | 2 | 0 | 1003 | 0 | 28.94 |
| 0 | 2 | 2 | 328 | 0 | 28.34 |
| 0 | 3 | 0 | 581 | 0 | 25.52 |
| 2 | −1 | 3 | 276 | 180 | 23.71 |
| 2 | 2 | 0 | 1080 | 0 | 22.10 |
| 0 | 3 | 2 | 261 | 0 | 21.83 |
| 1 | 3 | 0 | 842 | 180 | 21.23 |
| 0 | 0 | 4 | 678 | 0 | 21.07 |
| 0 | 4 | 0 | 775 | 0 | 19.14 |
| 2 | −1 | 4 | 157 | 0 | 19.02 |
| 2 | 3 | 0 | 310 | 180 | 17.56 |
| 4 | −2 | 3 | 127 | 180 | 17.37 |
| 1 | 4 | 0 | 52 | 0 | 16.71 |
| 0 | 5 | 0 | 420 | 180 | 15.31 |
| 3 | 3 | 0 | 172 | 0 | 14.73 |
| 6 | −3 | 1 | 97 | 180 | 14.51 |
| 2 | 4 | 0 | 185 | 180 | 14.47 |
| 1 | 5 | 0 | 222 | 0 | 13.75 |
| 0 | 0 | 6 | 104 | 0 | 14.05 |
| 0 | 6 | 0 | 173 | 180 | 12.76 |
| 3 | 4 | 0 | 103 | 0 | 12.59 |
| 2 | 5 | 0 | 83 | 0 | 12.26 |

The amplitudes and phases were obtained from the HRTEM images using the program CRISP. The final electrostatic potential map was calculated using the reflections with the amplitudes larger than 500.

TABLE 3
Amplitudes and phases of the structure factors of IBN-6.

| h | k | l | Amplitude | Phase | d (Å) |
|---|---|---|---|---|---|
| 1 | 1 | 2 | 10000 | 0 | 37.15 |
| 0 | 2 | 2 | 5062 | 0 | 32.17 |
| 1 | 2 | 3 | 16 | 180 | 24.32 |
| 0 | 0 | 4 | 354 | 180 | 22.75 |
| 0 | 2 | 4 | 964 | 180 | 20.35 |
| 2 | 3 | 3 | 985 | 0 | 19.40 |

The amplitudes were extracted from the powder XRD pattern, and the phases were obtained from the HRTEM images using the program CRISP.

The defocus values of HRTEM images were determined experimentally, and the effects of the contrast transfer functions at those defocus values were compensated for. The structure factors of reflections from different projections were merged into a 3D data set by adjusting the origin and scaling the amplitudes by common reflections. Reflections with amplitudes that were over 5% of the amplitude of the strongest reflection were used to generate 3D electrostatic potential maps using the program eMap [Oleynikov, P. eMap: A program for computational crystallography http://www.analitex.com (2008).

### Discussion

The present example relates to production and characterization of a tri-continuous mesoporous material IBN-9 with the silica pore wall following a hexagonal minimal surface. Thus there is described the first three-dimensional (3D) hexagonal mesoporous silica ISN-9 with tri-continuous pore structures. IBN-9 was synthesized by using a specially designed cationic surfactant template. The structure consists of three identical continuous interpenetrating channels, which are separated by silica walls that follow a hexagonal minimal surface (H-surface). Such a tri-continuous mesostructure was predicted mathematically, but has never been observed before in real materials, including soft matters. IBN-9 is found to be an intermediate mesophase between the gyroid bi-continuous cubic mesophase (IBN-6) and the two-dimensional (2D) hexagonal mesophase (IBN-10). The three mesophases could be obtained with the same surfactant template, by slightly modifying the synthesis conditions.

As mesoporous silicas are synthesized via co-assembly of organic surfactant molecules and inorganic silicate species in aqueous solutions, their structures depend heavily on the properties of the surfactant templates. The influence of a surfactant molecule on the mesostructures is associated with the surfactant packing parameter, g=V/a₀l (V=the volume of the hydrophobic chain, a₀=the effective area of the polar head group; l=the chain length). In general, a smaller g favors the formation of a mesophase with higher surface mean curvatures. A continuous increase in surface mean curvatures could lead to lamellar-bi-continuous-columnar-globular mesophase transitions. A number of branched minimal surface models were proposed recently, and two of them (one hexagonal and one cubic) are tri-continuous, which have been predicted as intermediate phases between the bi-continuous and 2D hexagonal columnar phases based on their surface mean curvatures. The inventors have now designed and synthesized a novel cationic surfactant (S)-(1-tetradecylcarbornyl-2-phenyl-ethyl)-dimethyl-ethyl-ammonium bromide (denoted as surfactant 2) in attempt to derive a tri-continuous mesoporous silica. Compared to the commonly used alkyltrimethylammonium surfactants that lead to 2D hexagonal columnar mesophases under most conditions, surfactant 2 has a larger head group (a₀) that favors the formation of mesophases with high surface mean curvatures. On the other hand, surfactant 2 has a hydrophobic (phenyl) side group that tends to enter the hydrophilic-hydrophobic “palisade” region of the micelles, increasing the volume of the hydrophobic core (V). This would facilitate the formation of mesophases with low surface mean curvatures. The combination of the two opposing effects of surfactant 2 would allow for a fine tuning of the surfactant packing parameter by modifying the synthesis conditions, thus offering great opportunities to obtain novel intermediate mesophases.

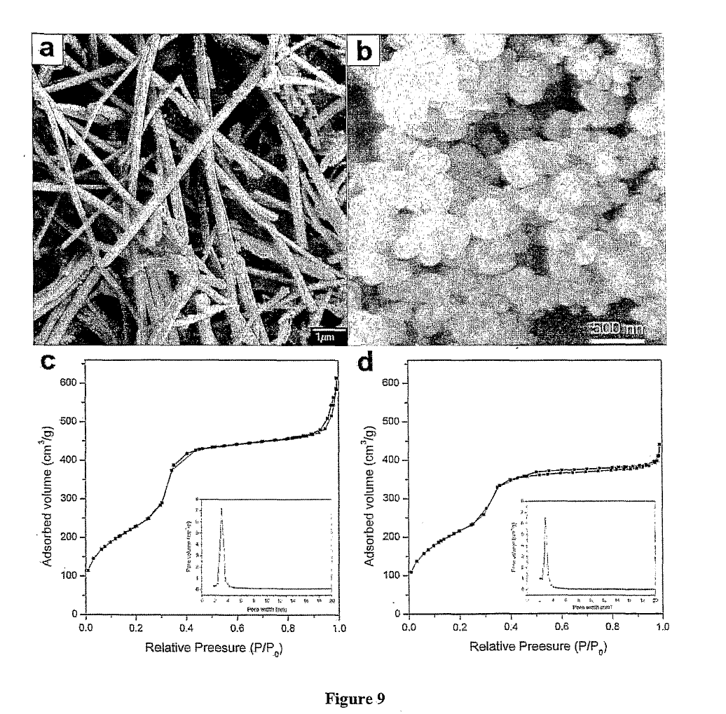

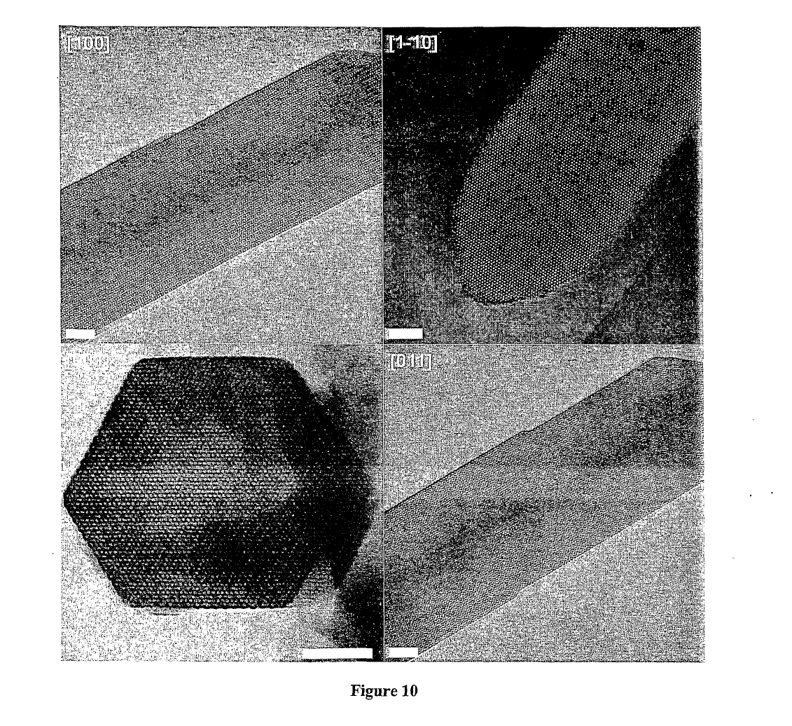

IBN-9 was synthesized using surfactant 2 as the template and tetraethoxysilane (TEOS) as the silica source, with a surfactant/TEOS molar ratio of 0.1 in an aqueous solution of ammonia (2.0 wt %). The material exhibits a well-defined fiber morphology with diameters of 60-300 nm, lengths of 5-30 μm and 6/mmm point group symmetry (FIGS. 9a and 10). Powder X-ray diffraction (XRD) patterns (FIG. 9b) showed that IBN-9 has a highly ordered new mesostructure, but the overlapped peaks did not allow a complete structure determination. Electron crystallography has proven to be a powerful method for the determination of pore structures of ordered mesoporous materials. It was thus applied to solve the structure of IBN-9. The unit cell was determined as hexagonal with a=88.4 Å and c=84.3 Å from a tilting series of high-resolution transmission electron microscopy (HRTEM) images. All powder XRD peaks could be indexed using the unit cell. The reflection conditions were determined as h-hl: l=2n and 00l: l=2n, from both the powder XRD and Fourier transforms of the HRTEM images. The projected symmetries of ISN-9 were pmm, pgg and p6 mm along the [110], [1-10] and [001] directions, respectively, determined from the HRTEM images using the crystallographic image processing software CRISP. Accordingly, the space group could be uniquely determined as P6₃/mcm (193). A 3D electrostatic potential map was reconstructed by combining the HRTEM images along the [110], [1-10] and [001] directions. The pore volume fraction of IBN-9 was 61.3%, as determined from the mesopore volume (0.72 cm³/g) deduced from the N₂ sorption isotherm (FIG. 9c) and silica wall density (2.2 g/cm³). The threshold for separating the pore from the silica wall in the electrostatic potential map was determined from the pore volume fraction. This threshold gave an average pore size of 3.2 nm and a surface area of 810 m²/g, well consistent with the values determined from the N₂ sorption isotherm (BJH pore size=3.0 nm, BET surface area=842 m²/g).

IBN-9 exhibits a unique tri-continuous structure with three congruent interwoven mesoporous channel systems separated by a single continuous silica wall. The structure is characterized by a series of zig-zag channels in parallel to the c axis. The zig-zag channels are further connected by “ternate channels” perpendicular to the c axis (FIG. 3b). The channel systems can be described as straight rods interconnected by different nodes (at (0, 0, 0.25) and (0.45, 0.45, 0.25) and their symmetry equivalents) (FIGS. 3c and 3d). Each channel system follows a three-connected etc net [O'Keeffe, M. et al. Reticular Chemistry Structure Resource http://rcsr.anu.edu.au/], consisting of uniform 8-membered rings and has the P6₃/mmc (194) symmetry. The three channel systems are shifted by a or b with respect to each other, forming an interpenetrating etc-c3 net. IBN-9 is the first reported structure representing the etc-c3 net. Interestingly, it has the same topological network as the tri-continuous branched hexagonal minimal (H-minimal) surface. The inventors simulated the H-minimal surface according to the cell parameters of IBN-9 using the software Surface Evolver [Brakke, K. The Surface Evolver. Experimental Mathematics 1, 141-165 (1992)], and superimposed it on the pore structure model. The silica wall of IBN-9 was found to follow the H-minimal surface well, dividing the structure into three identical spaces. IBN-9 represents the first example of H-minimal surfaces in real materials, and a new mesophase distinguished by its tri-continuous pore structure and P6₃/mcm hexagonal symmetry.

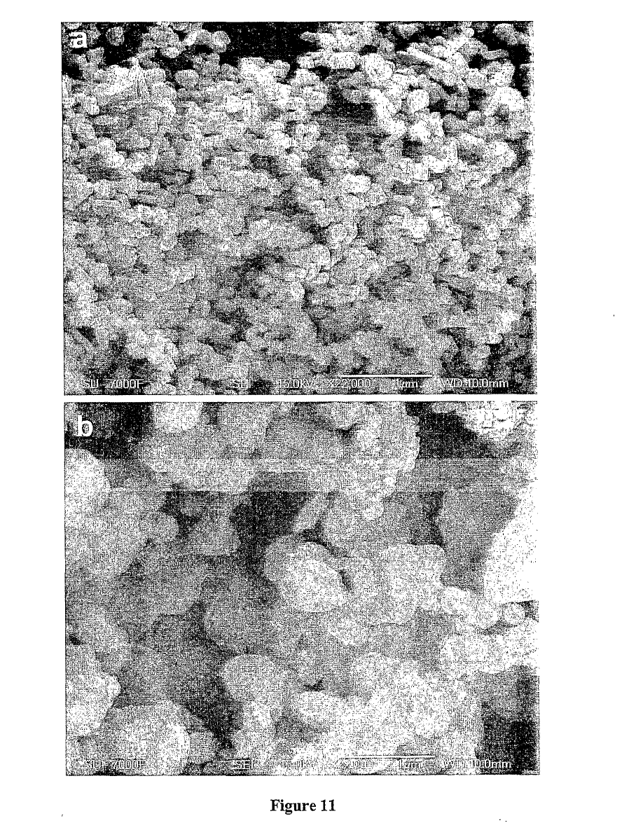

Further studies showed that IBN-9 could be synthesized over a wide range of ammonia concentrations, from 0.5 wt % (pH=10.4) to 15 wt % (pH=12.6), using surfactant 2 as the template. The nanofiber morphology could only be obtained when the ammonia concentration was less than 2.5 wt % (pH=11.9). An important aspect in controlling the fiber morphology was to kinetically control the hydrolysis rate of the silicate species at a two-phase interface. In the synthesis, the silica precursor TEOS was added under a static condition to form an “oil” phase on top of the aqueous ammonia solution that contained surfactant 2. Without any disturbances, TEOS was slowly hydrolyzed at the oil/water interface whereby the resulting silicates assembled with the surfactant molecules to nucleate the mesophase. Since more surfactant was available in the aqueous phase, the silicate/surfactant nanocomposite would grow from the oil/water interface towards the aqueous solution, leading to the formation of fibers. When the synthesis was performed under continuous stirring instead of a static condition, TEOS would be uniformly dispersed in the ammonia solution within a short period, resulting in rapid, uncontrolled silicates hydrolysis/condensation leading to particles with irregular shapes. Likewise, a highly concentrated ammonia solution would not be favorable towards fiber formation since the high pH would give rise to rapid TEOS hydrolysis. For example, IBN-9 particles synthesized in 5 wt % and 10 wt % ammonia solutions appeared as spherical or disk-like particles instead of fibers (FIG. 11). For the IBN-9 fibers, the c axis is along the fiber direction, so that the zig-zag channels along the c axis are extremely long, while those perpendicular to the c axis are very short.

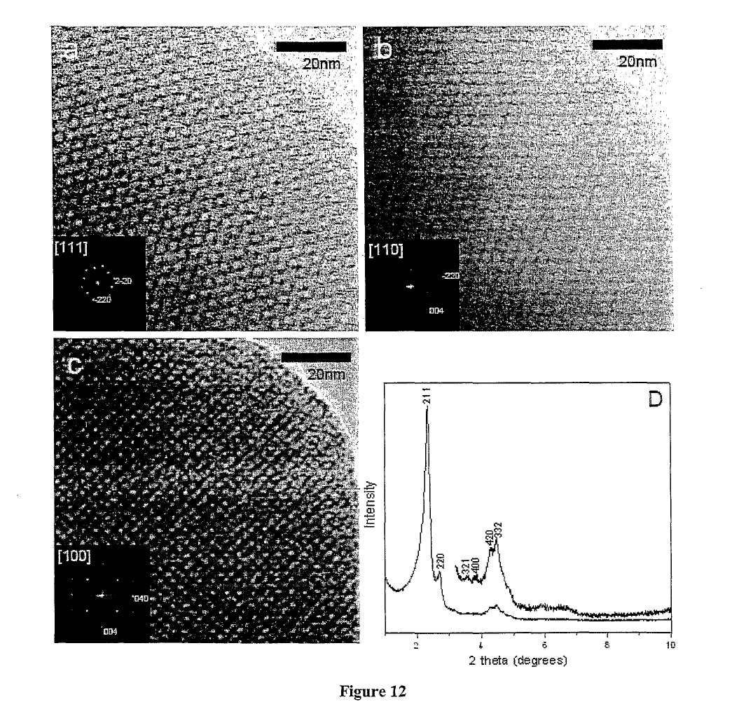

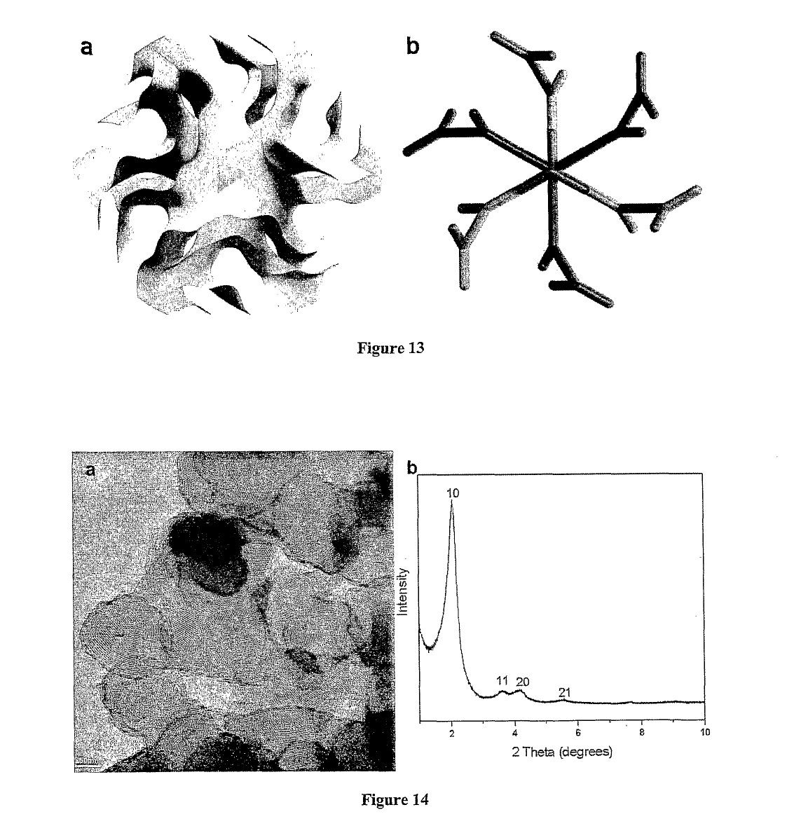

Two other mesophases were synthesized using the same surfactant 2 by modifying the synthesis conditions of ISN-9. A bi-continuous mesostructure IBN-6 was obtained by simply using a more concentrated ammonia solution (>20 wt %), while keeping the other synthesis conditions unchanged (FIG. 9b). Powder XRD and TEM studies confirmed that IBN-6 has a cubic Ia-3d (MCM-48-type) structure with a=91.0 Å (FIG. 12). The 3D electrostatic potential map reconstructed from HRTEM images along the [111], [110] and directions clearly shows the bi-continuous gyroidal pore systems separated by the G-surface. Each channel system follows a three-connected srs net, and the two channel systems form an enantiomorphic pair with opposite handedness (FIG. 13). Compared to IBN-9, IBN-6 has a slightly smaller pore size (2.7 nm) and a lower mesopore volume (0.60 cm³/g), determined from the reconstructed electrostatic potential map and supported by the N₂ sorption isotherm (FIG. 9d). The other mesophase (IBN-10) was obtained over a wide range of ammonia concentrations (from 0.5 wt % to 25 wt %) with a reduced surfactant/TEOS molar ratio (below 0.05). IBN-10 has a 2D hexagonal structure with a=45 Å (FIG. 14).

The surface mean curvatures of the three different mesophases were analysed in order to understand their structural relationship. Mean curvatures were calculated for the three mesophases based on their experimental silica wall surfaces obtained from the reconstructed electrostatic potential maps. The average mean curvature increases from the cubic IBN-6 (0.01(3) nm⁻¹) to the 3D hexagonal IBN-9 (0.16(14) nm⁻¹) and to the 2D hexagonal IBN-10 (0.30(7) nm⁻¹). While IBN-6 and IBN-10 show nearly constant mean curvatures over the entire silica wall, IBN-9 has a larger mean curvature variation. The regions with high mean curvatures in IBN-9 are associated with the zig-zag channels along the c axis, with the mean curvatures similar to those in IBN-10. The regions associated with the ternate channels, on the other hand, have low mean curvatures close to those of the gyroidal channels in IBN-6. This indicates that IBN-9 may be an intermediate phase between the bi-continuous cubic mesophase and the 2D hexagonal mesophase. The transition from the bi-continuous channels of interpenetrating srs nets in IBN-6 through the tri-continuous channels of the etc-c3 net in IBN-9 to the 1D channels in IBN-10 is associated with the increase in surface mean curvatures.

The mean curvatures were controlled by the interactions between the inorganic silicate species and the organic surfactant molecules. The stronger alkalinity associated with the higher ammonia concentration in the synthesis of IBN-6 would lead to a higher negative charge density of the silicate species. To maintain a matching charge density, the cationic surfactant molecules would adopt a more compact packing to form micelles with lower mean curvatures when they cooperatively assembled with the silicate species into mesostructures. On the other hand, a lower surfactant/TEOS ratio in the synthesis of IBN-10 would be likely to favour the formation of a 2D hexagonal mesophase with higher mean curvatures.

The inventors have for the first time synthesized a tri-continuous mesoporous silica IBN-9 with hexagonal symmetry P6₃/mcm by using a specially designed surfactant as the template. IBN-9 has the most complex pore structure amongst all reported mesoporous materials. It consists of three interwoven but disconnected channel systems that are separated by a continuous silica wall. Each channel system contains 3D interconnected zig-zag channels. The material could be prepared as fibers and disks. These unique features of IBN-9 are particularly interesting for separation and controlled release applications. The inventors believe that IBN-9 is an intermediate phase between the cubic bi-continuous phase and the 2D hexagonal phase.

1. A process for making a tricontinuous particulate mesoporous material comprising:
combining a solution comprising a surfactant and a base with a hydrolysable precursor without agitating said solution, said surfactant comprising a trialkylammonium head group and a tail group which comprises an aryl group; and
allowing the resulting mixture to stand without externally applied agitation for sufficient time for hydrolysis of the precursor to form the particulate mesoporous material.

2. The process of claim 1 wherein the surfactant is such that the concentration of the base in the solution controls the shape of particles of the particulate mesoporous material and/or the mesoporous structure of the particulate mesoporous material.

3. The process of claim 2 wherein the mesoporous structure of the particulate mesoporous material may have a 3D hexagonal P6₃/mmc, P6₃/mcm, cubic Ia 3̅d, 2D hexagonal p6 mm or cubic Pm 3̅n mesophase, depending on the concentration of the base in the solution.

4. The process of claim 1 wherein the base is a water soluble amine or is ammonia.

5. (canceled)

6. The process of claim 1 wherein the hydrolysable precursor is selected from the group consisting of tetraalkoxysilanes, alkyltrialkoxysilanes, tetraalkyltitanates, tetraalkylzirconates and mixtures of any two or more of these.

7. The process of claim 1 wherein the hydrolysable precursor comprises a tetraalkoxysilane and/or an alkyltrialkoxysilane, whereby the mesoporous material comprises mesoporous silica and/or mesoporous alkyl silsesquioxane.

8. The process of claim 7 wherein the hydrolysable precursor is tetraethoxysilane, whereby the mesoporous material comprises mesoporous silica.

9. The process of claim 1 wherein the concentration of the base in the solution is such that the mesoporous material is in the form of nanofibres having a 3D hexagonal P6₃/mmc, P6₃/mcm or a cubic Pm 3̅n mesophase.

10. The process of claim 1 wherein the concentration of base in the solution is such that the mesoporous material is in the form of nanofibres having 6/mmm point group symmetry.

11. The process of claim 1 wherein the concentration of base in the solution is such that the mesoporous material is in the form of nanofibres and has a tricontinuous structure.

12. The process of claim 10 wherein the base is ammonia, said ammonia being in a concentration of about 0.5 to about 15 wt % in the solution.

13. The process of claim 1 wherein the tail group comprises a long chain alkyl group which is not attached directly to the aryl group.

14. The process of claim 1 wherein the surfactant is chiral.

15. The process of claim 1 wherein the surfactant is(S)-(1-tetradecylcarbornyl-2-phenyl-ethyl)-dimethyl-ethyl-ammonium bromide.

16. The process of claim 1 additionally comprising the step of calcining the resulting mesoporous material at a temperature and for a time sufficient to remove substantially all of the surfactant.

17. The process of claim 1 wherein the surfactant is a (S)-(1-tetradecylcarbornyl-2-phenyl-ethyl)-dimethyl-ethyl-ammonium halide, the base is ammonia at a concentration in the solution of about 0.5 to about 15%, the hydrolysable precursor is tetrethoxysilane and the process comprises calcining an initially formed mesoporous material at about 500 to about 600° C., whereby the particulate mesoporous material is mesoporous silica having a tricontinuous structure.

18. A particulate mesoporous material having a tricontinuous structure.

19. The mesoporous material of claim 37 having a 3D hexagonal P6₃/mmc, P6₃/mcm or a cubic Pm 3̅n mesophase.

20. The mesoporous material of claim 37 having 6/mmm point group symmetry.

21-36. (canceled)

37. The particulate mesoporous material of claim 18, said material being in the form of nanofibres.
